(19) United States
(12) Patent Application Publication
(10) Pub. No.: US 2006/0146099 A1
(43) Pub. Date: Jul. 6, 2006

(54) Micro droplet control apparatus

(75) Inventors: Chun-Han Wang, Kaohsiung City (TW); Han-Sheng Chuang, Taipei City (TW); Cheng-Tsair Yang, Miaoli County (TW); Guang-Chyan Fang, Hsinchu City (TW); Da-Jeng Yao, Taipei City (TW)

Correspondence Address: QUINTERO LAW OFFICE, 1617 BROADWAY, 3RD FLOOR, SANTA MONICA, CA, 90404, US

(73) Assignee: INDUSTRIAL TECHNOLOGY RESEARCH INSTITUTE, HSINCHU (TW)

(21) Appl. No.: 11/321,956

(22) Filed: Dec. 28, 2005

(30) Foreign Application Priority Data
Dec. 31, 2004 (TW) TW93141733

(51) Int. Cl. B41J 2/02

(52) U.S. Cl. 347/75

(57) ABSTRACT

A micro droplet controlling apparatus. A dielectric layer is disposed overlying a substrate. A first electrode and a second electrode are disposed in the dielectric layer, wherein the first electrode is isolated from the second electrode, and the first and second electrodes are disposed at different positions. A micro droplet is disposed overlying the dielectric layer, wherein the first electrode and the second electrode are applied with voltage to generate a driving force to move the micro droplet.

### BACKGROUND

The invention relates to a control apparatus and fabrication thereof, and in particular to a droplet controlling apparatus.

Currently, labs on chip are small in size and convenient to carry, but only have a single function. This may not meet the requirement for diverse application. In addition to wasting samples, contamination issues, conventional continuous droplet operation technology wastes kinetic energy of a droplet due to higher surface rubbing. Further, conventional devices require an additional driving source and detection apparatus. Droplets can be controlled by electrowetting technology, but space is limited by opposite electrode layers, which hinders multi-droplet operations. This limitation could affect inspection of samples, such as for a gene device or a protein device.

U.S. Pat. No. 6,565,727 illustrates a multi-layer electrode structure for controlling movement of the droplet therebetween. Due to electrodes and substrates on opposite sides of droplets, apparatus functions, however, are limited. For example, inspection and addition of a droplet additive is difficult.

### SUMMARY

These and other problems are generally solved or circumvented, and technical advantages are generally achieved, by preferred illustrative embodiments of the present invention, which provide a droplet control apparatus and fabrications thereof.

An embodiment of the invention provides a micro droplet controlling apparatus. A dielectric layer is disposed overlying a substrate. A first electrode and a second electrode are disposed in the dielectric layer, wherein the first electrode is isolated from the second electrode, and the first and second electrodes are disposed at different positions. A micro droplet is disposed overlying the dielectric layer, wherein voltage is applied to the first electrode and the second electrode are to generate a driving force to move the micro droplet.

Another embodiment of the invention provides a micro droplet controlling apparatus. A dielectric layer is disposed overlying a substrate. A first electrode and a second electrode are disposed in the dielectric layer, wherein the first electrode is isolated from the second electrode, and the first and second electrodes are disposed at different positions. The first electrode comprises a plurality of electrode regions arranged in a matrix, and the electrode regions are surrounded by the second electrode. A micro droplet is disposed overlying the dielectric layer, wherein the first electrode and the second electrode are applied with voltage to generate a driving force to move the micro droplet.

Yet another embodiment of the invention provides a micro droplet controlling apparatus. A dielectric layer is disposed overlying a substrate. A plurality of first electrodes is disposed in the dielectric layer. A plurality of second electrodes are disposed overlying the dielectric layer, wherein the first electrodes do not overlap the second electrodes. A hydrophobic layer is dispose overlying the dielectric layer, covering the second electrodes. A micro droplet is disposed overlying the hydrophobic layer, wherein the first electrodes and the second electrodes are applied with voltage to generate a driving force to move the micro droplet.

In some embodiments of a method for controlling a micro droplet, a plurality of first electrodes are provided in a row direction overlying a substrate. A plurality of second electrodes are provided in column direction overlying a substrate to form a matrix with the first electrodes, wherein the first electrodes do not overlap the second electrodes. A hydrophobic layer is formed to cover the first electrodes and the second electrodes. At least a micro droplet is provided on the hydrophobic layer. The first electrodes and the second electrodes is conducted row by row or column by column using a matrix scanning method to generate a driving force to move the micro droplet.

### BRIEF DESCRIPTION OF THE DRAWINGS

The invention can be more fully understood by reading the subsequent detailed description and examples with references made to the accompanying drawings, wherein:

FIG. 1 is a cross section of a single side electrode droplet control device of embodiment of the invention.

FIG. 2A˜FIG. 2D illustrate methods to increase contact angles of a droplet to a surface thereunder of embodiments of the invention.

FIG. 3A˜FIG. 3D illustrate electrode structures of single electrowetting of embodiments of the invention.

FIG. 4A is a cross section of an electrowetting electrode structure of another embodiment of the invention.

FIG. 4B shows a top view of an electrowetting electrode structure of another embodiment of the invention.

FIG. 4C illustrate a plurality of droplets controlled at the same time in a further embodiment of the invention.

FIG. 5A, FIG. 5B and FIG. 5C are relation curves of applied voltage and inner pressure difference.

FIG. 6A˜FIG. 6C illustrate a method for forming the droplet controlling apparatus of yet another embodiment of the invention.

FIG. 7 shows programmable micro droplet inspection apparatus of an embodiment of the invention.

### DETAILED DESCRIPTION OF THE INVENTION

The following description discloses the best-contemplated mode of carrying out the invention. This description is made for the purpose of illustrating the general principles of the invention and should not be taken in a limiting sense. The scope of the invention is best determined by reference to the appended claims.

In this specification, expressions such as “overlying the substrate”, “above the layer”, or “on the film” simply denote a relative positional relationship with respect to the surface of the base layer, regardless of the existence of intermediate layers. Accordingly, these expressions may indicate not only the direct contact of layers, but also, a non-contact state of one or more laminated layers.

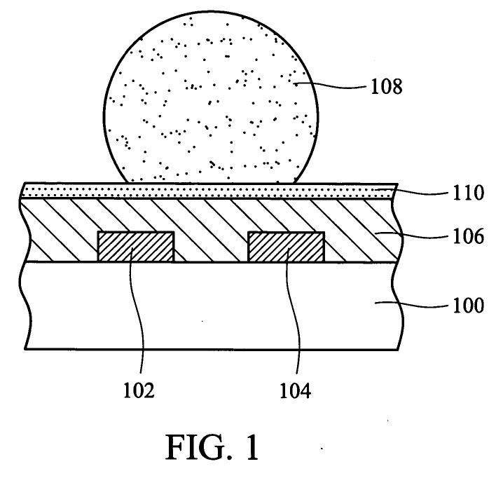

FIG. 1 is a cross section of a single side electrode droplet control device of an embodiment of the invention. As shown in FIG. 1, a first electrode 102 and a second electrode 104 are formed on a same surface of a substrate 100, such as glass substrate, semiconductor substrate, silicon substrate or a printed circuit board. The first electrode 102 and the second electrode 104 can comprise conductive materials, such as gold, aluminum or cupper. In a preferred embodiment of the invention, the first electrode 102 and the second electrode 104 are gold, the invention, however, is not limited thereto.

A dielectric layer 106 covers the substrate 100, the first electrode 102 and the second electrode 104 for protection and isolation. The dielectric layer 106 can comprise dielectric materials, such as silicon oxide, silicon nitride, silicon oxynitride or photoresist. In a preferred embodiment of the invention, the dielectric layer 106 is photoresist. A droplet 108 contacts a surface thereunder and has resistance therebetween when moving. A principle of the electrowetting method is to change a contact angle of the droplet 108 and the surface thereunder. Thus, the characteristic of a hydrophobic layer 110 on a substrate 100 surface is important. Voltage is applied to the droplet 108 to change surface energy, thus, contact angle is adjusted therebetween. The droplet 108 can move when connect angles on opposites thereof are different, and unbalanced pressure occurs. As well, driving force of the droplet 108 increases when contact angle difference increases. In order to achieve a larger sensitivity to voltage of a droplet, contact angle between the droplet 108 and the surface thereunder with no applied voltage should be as large as possible. Increase of contact angle includes two methods. One is coating hydrophobic materials, such as Teflon, on the substrate to form a hydrophobic layer. Another is increasing roughness of a surface of a layer, such as the dielectric layer or the hydrophobic layer, underlying the droplet. According to lotus effect, increase of surface roughness can be achieved by increasing contact angles between a droplet and the surface.

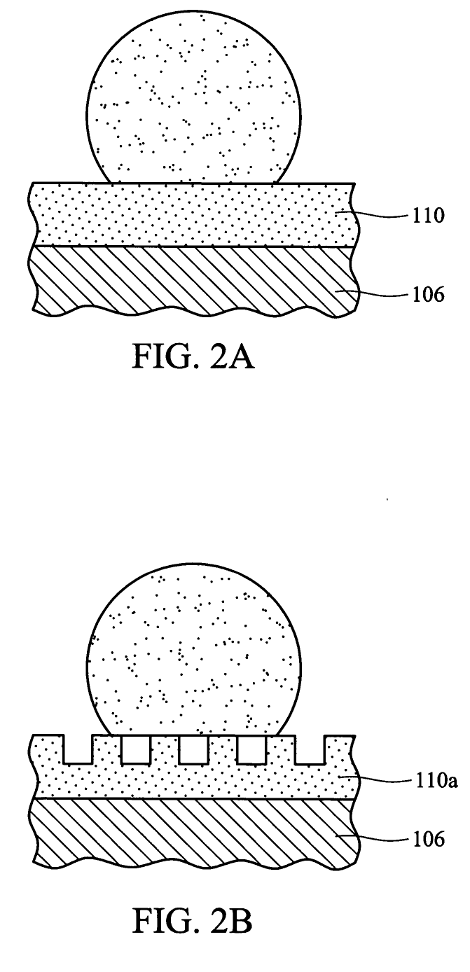

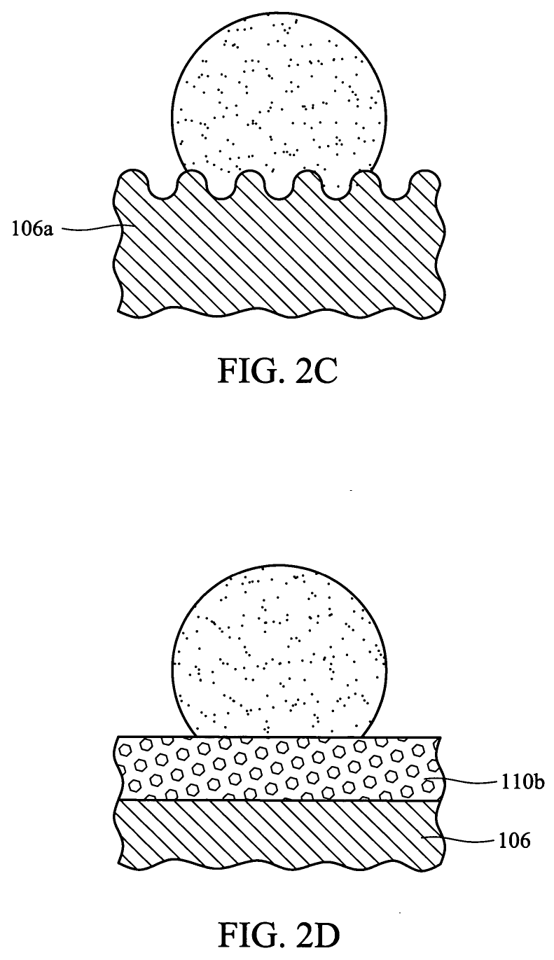

FIG. 2A˜FIG. 2D illustrate methods to increase contact angles between a droplet and a surface thereunder of an embodiment of the invention. As shown in FIG. 2A, a hydrophobic layer 110, comprising hydrophobic materials, is formed on a dielectric layer 106. Alternatively, as shown in FIG. 2B, the hydrophobic layer 110a overlying the substrate can be treated by lithography and etching or only etching to achieve a rough surface. In addition, as shown in FIG. 2C, in another embodiment of the invention, the dielectric layer 106a underlying the droplet can be etched to achieve a rough surface. Further, as shown in FIG. 2D, a thin film 110b of organic materials with hydrophobic bonds can be coated on the dielectric layer 106.

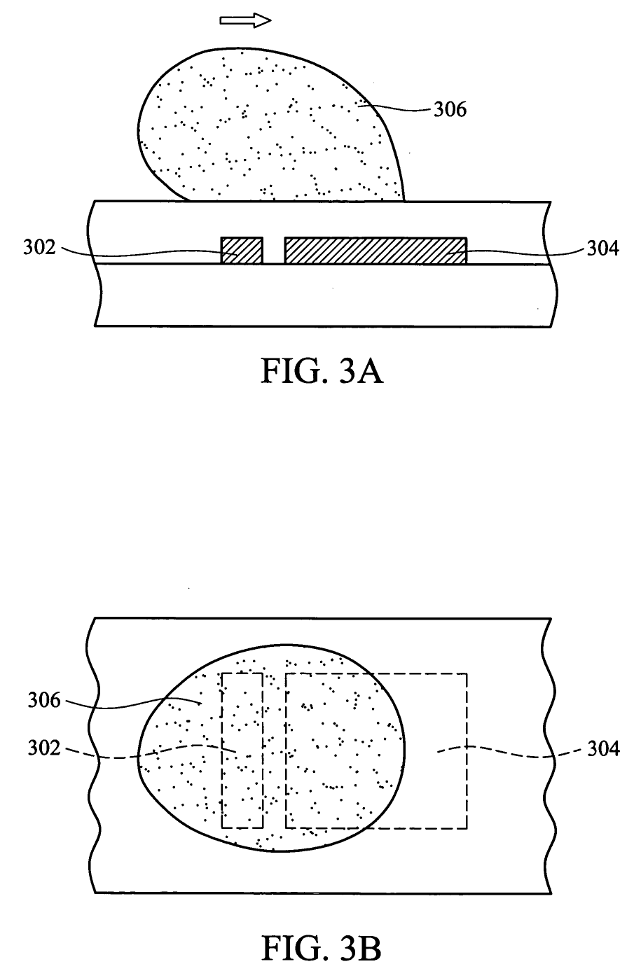

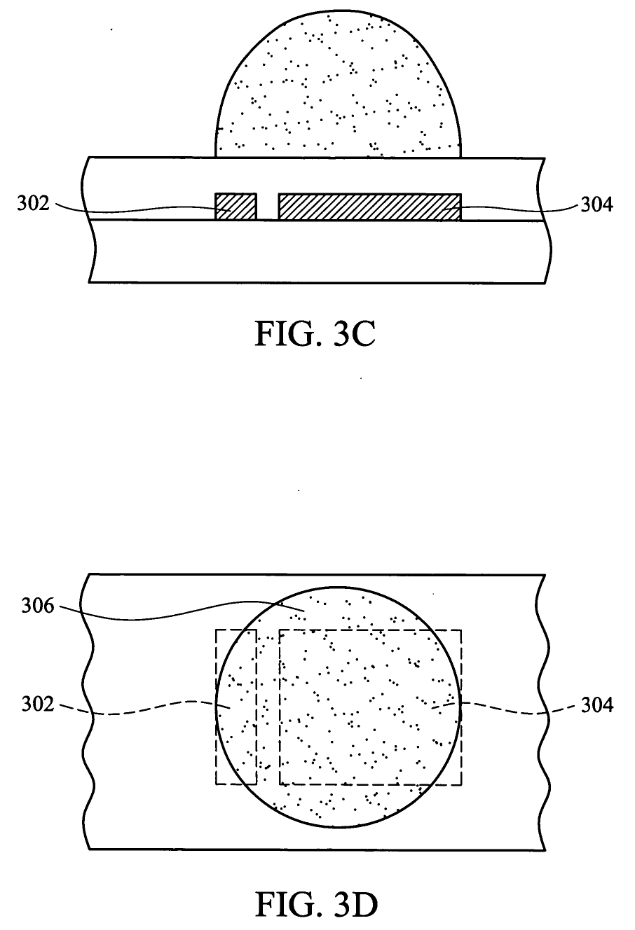

FIG. 3A˜FIG. 3D illustrate electrode structure of single electrowetting of embodiments of the invention. FIG. 3A shows a cross section prior to removal of the droplet. FIG. 3B shows a top view prior to removal of the droplet. FIG. 3C shows a cross section subsequent to removal of the droplet. FIG. 3D shows a top view subsequent to removal of the droplet. Driving force of the droplet is related to voltage, and is not concerned with polarization of charge. A droplet will not move if areas covering portions of two electrodes are the same. Preferably, a positive and a negative electrode, such as the first electrode 302 and the second electrode 304, have different area to cause the droplet unbalanced to move. More preferably, the first electrode 302 is several times larger or smaller than the second electrode 304. As shown in FIG. 3A and FIG. 3B, right portion of the droplet 306 overlaps a larger area electrode 304, and the left portion overlaps a smaller area electrode 302, thus, the droplet 306 moves rightward. The droplet 306 stops moving when two sides of the droplet 306 have the same electrowetting driving force, as shown in FIG. 3C and FIG. 3D.

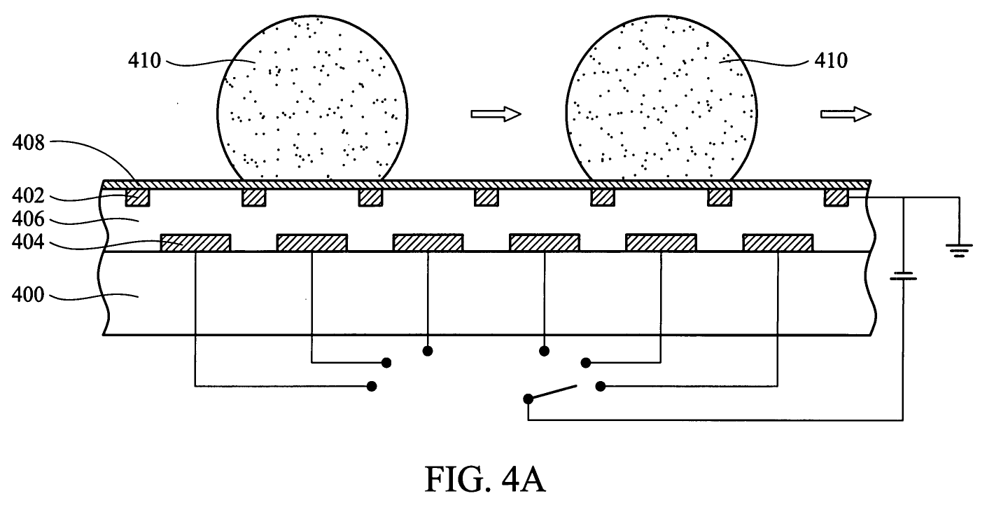

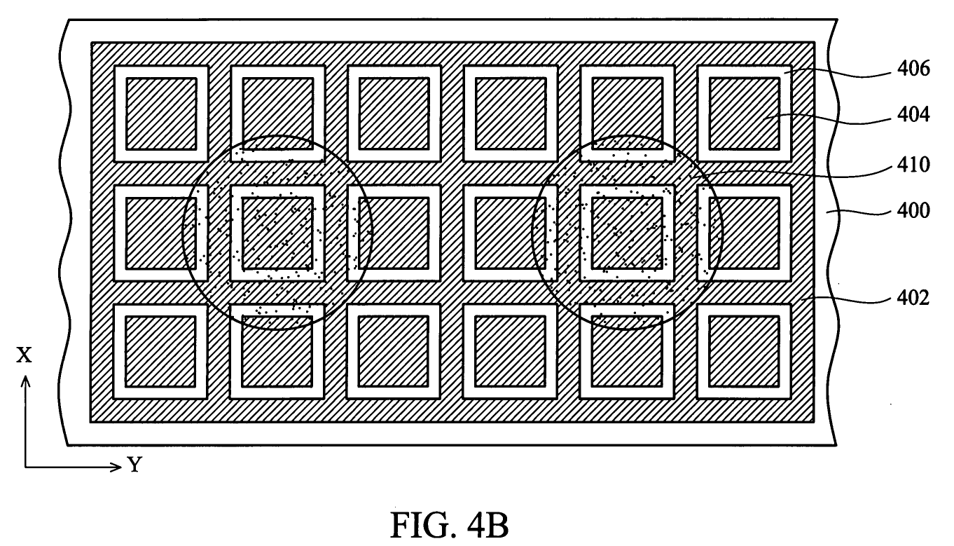

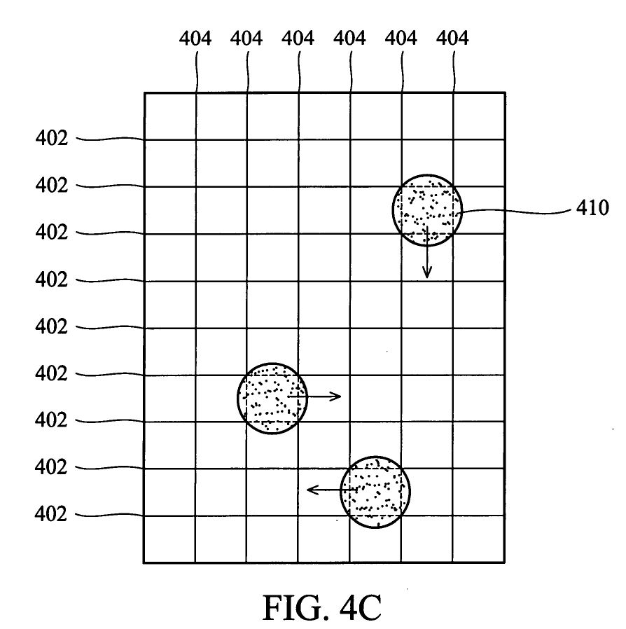

In FIG. 1, a electric current flows from the first electrode 102 to the second electrode 104 through the isolation layer 106, the droplet 108, the isolation layer 106 again, in which voltage drops twice at the isolation layer 106. The hydrophobic layer 110 can be neglected due to thin thickness. In order to solve this voltage drop issue, the invention provides another electrowetting electrode structure. As shown in FIG. 4A, a cross section of an electrowetting electrode structure of an embodiment of the invention, a plurality of second electrodes 404 are disposed on the substrate 400. A dielectric layer 406 covers the second electrodes 404. A plurality of first electrodes 402 are disposed on or in the dielectric layer 406, in which the first electrodes 402 are aligned to the interval between two adjacent second electrodes 404. A hydrophobic layer 408 is disposed on the dielectric layer 406 and the first electrodes 402. In an embodiment of the invention, voltages applied to the first electrode 402 and the second electrode 404 are reverse. In another embodiment of the invention, one of the first electrode 402 and second electrode 404 is ground, and another is applied with voltage, in which either positive voltage or negative voltage is acceptable. Preferably, the first electrode 402 is ground and the second electrode 404 is applied with voltage. Thus, the second electrode 404 is separated from the droplet 410 with a dielectric layer 406, and the first electrode 402 is not separated from the droplet 410 to increase driving force. If both the first electrode 402 and the second electrode 404 are separated from the droplet 410 by a dielectric layer 406, output voltage of both the electrodes is only about half the input voltage. In addition, in another embodiment of the invention, when only a thin hydrophobic layer is interposed between the first electrode and the droplet, leakage is likely to occur. Thus, the first electrode is ground, and the second electrode is ground to reduce leakage.

FIG. 4B shows a top view of an electrowetting electrode structure of an embodiment of the invention. In FIG. 4B, the second electrodes 404 comprise a plurality of electrode regions arranged in a matrix, wherein the electrode regions are surrounded by the first electrodes 402. Consequently, due to connection of the first electrodes 402 over the second electrodes 404, move of droplet 410 can be controlled by voltage applied to the second electrode 404. When electrodes neighboring the droplet 410 are applied with voltage, the droplet 410 can move to any direction according to integrated driving force.

Further, in a further embodiment of the invention a plurality of droplets can be simultaneously controlled. As shown in FIG. 4C, a plurality of first electrodes 402 arranged in a row direction are formed overlying the substrate, and a plurality of second electrodes 404 arranged in a column direction are formed overlying the substrate, intersecting with each other to form a matrix, wherein the first electrodes 402 do not overlap the second electrodes 404. A hydrophobic layer covers the first electrode and the second electrode. A plurality of droplets 410 are disposed on the hydrophobic layer. The first electrodes 402 and the second electrodes 404 are conducted row by row, or column by column in a matrix scanning way. Thus, a voltage difference is generated in the conducted first electrodes 402 and second electrodes 404 causing the droplet movement one row or one column at one time. The scanning method, in either X direction, Y direction or both, can be used to move a plurality of droplets. Each scan can move an electrode with an electrode unit, and when the scanning frequency reaches 30 Hz per droplet, the droplets 410 appear to move simultaneously to the human eye.

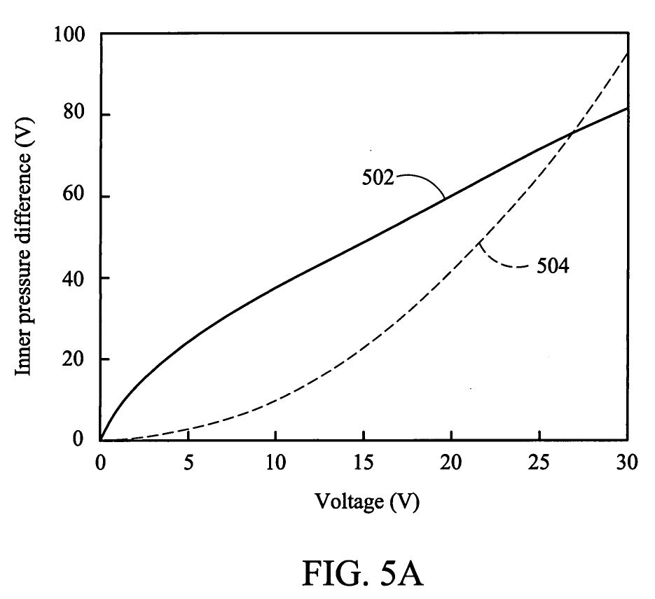

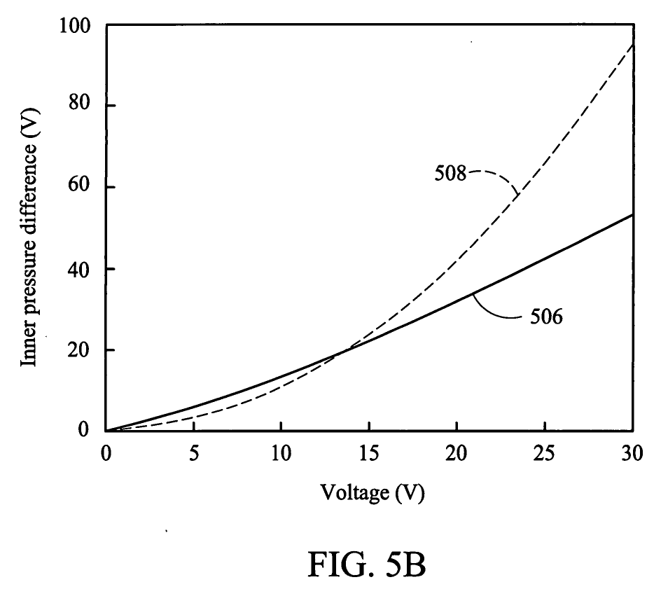

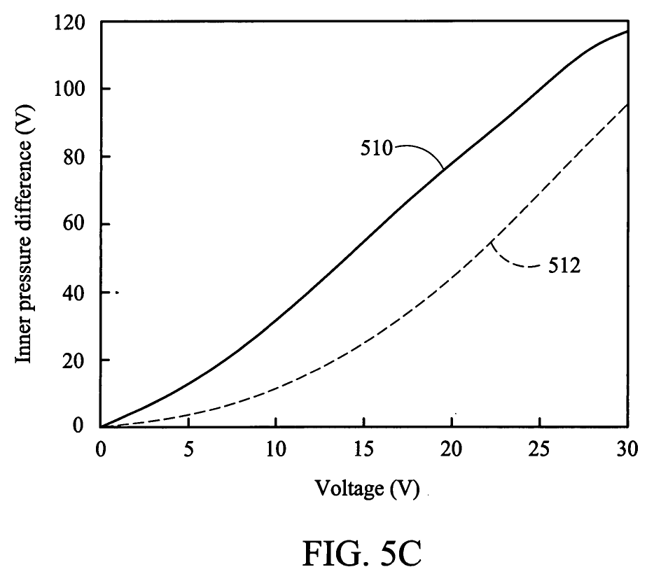

FIG. 5A, FIG. 5B and FIG. 5C are relationship curves of applied voltage and inner pressure difference, comparing the conventional technology and an embodiment of the invention. In FIG. 5A, curve 502 presents the result of single side electrowetting, and the curve 504 presents the result of double side electrowetting, in which both layers under the droplet in samples are dielectric layers with a rough surface. In FIG. 5B, curve 506 presents the result of single side electrowetting, and the curve 508 presents the result of double side electrowetting, in which both layers under the droplet in samples comprise Teflon. According to the curves, the sample with rough surface has better droplet movement efficiency than that with a Teflon surface. Curve 510 presents a relationship between applied voltage and pressure difference of single side electrowetting of the embodiment of FIG. 4A. Curve 512 presents a relationship between applied voltage and pressure difference of conventional double side electrowetting. According to curves 510 and 512, the preferred embodiment with another electrode structure has better droplet driving force than conventional technology.

The method for forming the droplet controlling apparatus of FIG. 1 comprises the following steps. A substrate 100 is provided, and a metal layer (not shown) is deposited on the substrate. Next, the metal layer is patterned by conventional lithography and etching to form a first electrode 102 and a second electrode 104. A dielectric layer 106 is formed on the substrate 100, the first electrode 102 and the second electrode 104 by deposition or coating. The dielectric layer 106 is patterned or treated to have a rough surface, or optionally, a hydrophobic layer 110 is formed on the dielectric layer 106, or further the hydrophobic layer 110 can also be treated to have a rough surface.

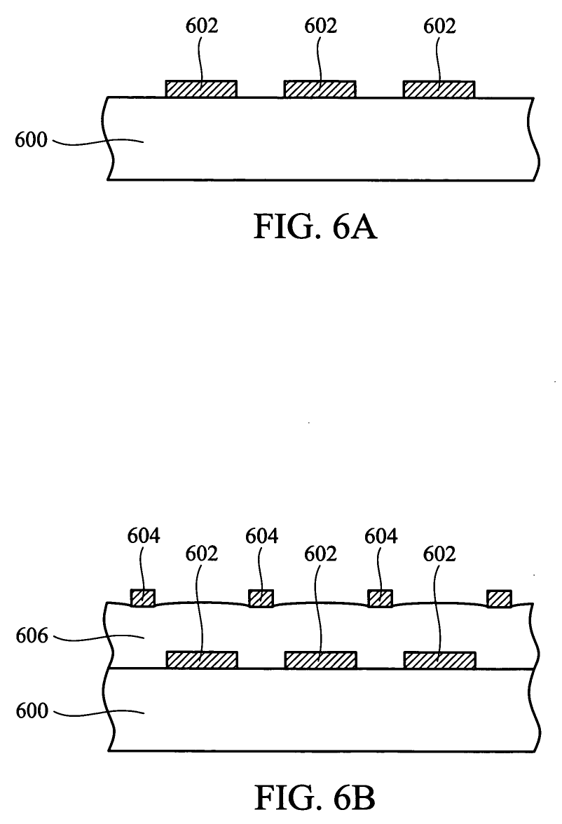

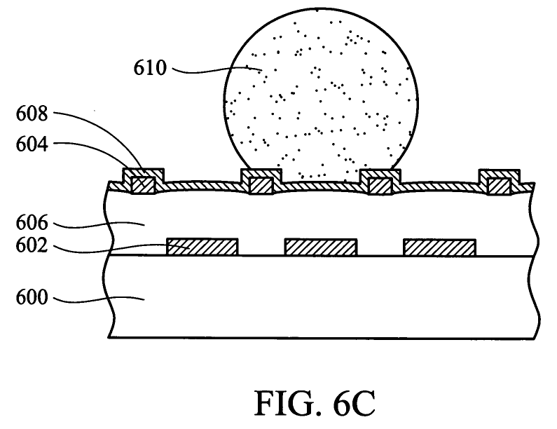

FIG. 6A˜FIG. 6C illustrate a method for forming the droplet controlling apparatus of another embodiment of the invention, wherein the first electrode and the second electrode are at different level. As shown in FIG. 6A, a substrate 600 is provided, and a metal layer (not shown) is deposited on the substrate 600. Next, the metal layer is patterned by conventional lithography and etching to form a plurality of second electrodes 602. As shown in FIG. 6B, a dielectric layer 606 is formed on the substrate 600 and the second electrodes 602 by deposition or coating. Next, a second metal layer (not shown) is deposited on the dielectric layer 606, and then patterned by conventional lithography and etching to form first electrodes 604, wherein the first electrodes 604 do not overlap the second electrodes 602. A hydrophobic layer 608 is formed on the dielectric layer 606 and the first electrodes 604. A droplet 610 on the hydrophobic layer 608 can be caused to move when a voltage applied to the first electrodes 604 and/or the second electrodes 602. The first electrode 604 and the second electrode 602 can comprise any conductive material, such as gold, aluminum, silver or cupper. Preferably, the first and second electrodes are gold. In addition, the dielectric layer 606 can comprise any dielectric material, such as silicon oxide, silicon nitride, silicon oxynitride or photoresist.

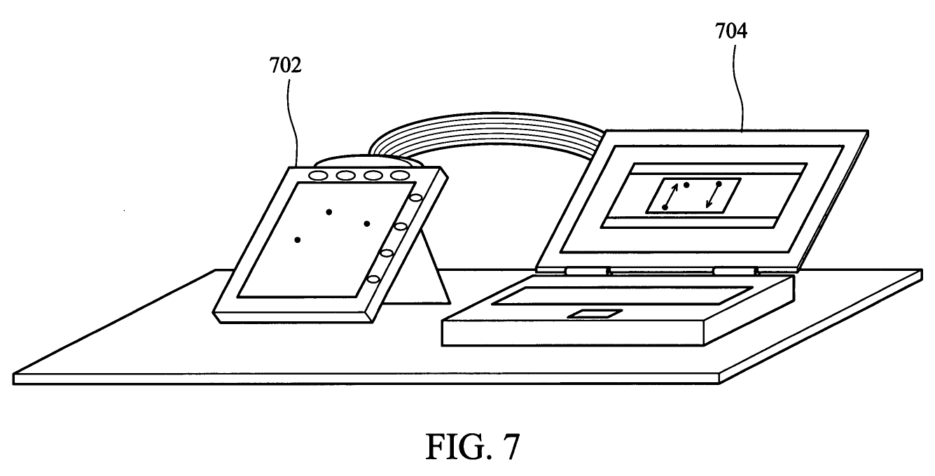

An electrowetting device capable of controlling every droplet is digital. FIG. 7 shows a programmable micro droplet inspection apparatus of an embodiment of the invention. The micro droplet inspection apparatus can be integrated with a calculation device, an inspection device or a control device, such as a computer 704. Electrodes, comprising the first electrode and the second electrode, of the micro droplet inspection apparatus 702 can be controlled with a computer to achieve real time operation. In addition, the micro droplet inspection apparatus 702 can further comprise a detector or an inspector, such as PH inspector for inspecting micro droplets. Because size of droplet is smaller and surface area of droplet is larger, the resolution can be better and the inspection can be more efficient. In addition, design of the micro droplet inspection apparatus 702 can be more flexible due to use of single side electrodes. The micro droplet inspection apparatus 702 can be integrated with computers to form a personal inspection apparatus.

By reducing contact area between a droplet and a surface thereunder, designing the electrodes, and treating the surface of the micro droplet controlling device, the driving voltage can be lower than in a conventional electrowetting device. In addition, the single side electrode of the micro droplet controlling device is more convenient in application. In accordance with the electrowetting device of a preferred embodiment of the invention, function limited, channel blocking, sample waste or contamination issues could be eliminated. Further, a micro flow channel could be replaced and a programmable digital droplet inspection system could be set according an embodiment of the invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A micro droplet controlling apparatus, comprising:
a substrate;
a dielectric layer disposed overlying the substrate;
a first electrode and a second electrode in the dielectric layer, wherein the first electrode is isolated from the second electrode, and the first and second electrodes are disposed at different positions; and
a micro droplet disposed overlying the dielectric layer, wherein the first electrode and the second electrode are applied with voltage to generate a driving force to move the micro droplet.

2. The micro droplet controlling apparatus as claimed in claim 1, wherein the first electrode and the second electrode do not overlap.

3. The micro droplet controlling apparatus as claimed in claim 1, wherein areas of the first electrode and the second electrode are different.

4. The micro droplet controlling apparatus as claimed in claim 3, wherein area of the first electrode is several times larger than that of the second electrode.

5. The micro droplet controlling apparatus as claimed in claim 1, wherein the second electrode is adjacent to top surface of the dielectric layer.

6. The micro droplet controlling apparatus as claimed in claim 5, wherein the second electrode is electrically ground.

7. The micro droplet controlling apparatus as claimed in claim 1, wherein the first electrode and the second electrode are adjacent to the substrate surface.

8. The micro droplet controlling apparatus as claimed in claim 1, further comprising a hydrophobic layer interposed between the micro droplet and the dielectric layer.

9. The micro droplet controlling apparatus as claimed in claim 8, wherein the hydrophobic layer comprises Teflon.

10. The micro droplet controlling apparatus as claimed in claim 1, wherein the dielectric layer comprises a rough surface.

11. The micro droplet controlling apparatus as claimed in claim 1, wherein the dielectric layer comprises a material selected from a group including silicon oxide, silicon nitride, silicon oxynitride, photoresist and combination thereof.

12. A micro droplet controlling apparatus, comprising:
a substrate;
a dielectric layer disposed overlying the substrate;
a first electrode and a second electrode in the dielectric layer, wherein the first electrode is isolated from the second electrode, and the first and second electrodes are disposed at different positions, the first electrode comprises a plurality of electrode regions arranged in a matrix, the electrode regions are surrounded by the second electrode; and
a micro droplet disposed overlying the dielectric layer, wherein the first electrode and the second electrode are applied with voltage to generate a driving force to move the micro droplet.

13. The micro droplet controlling apparatus as claimed in claim 12, wherein the second electrode is adjacent to top surface of the dielectric layer.

14. The micro droplet controlling apparatus as claimed in claim 13, wherein the second electrode is electrically ground.

15. The micro droplet controlling apparatus as claimed in claim 12, wherein the first electrode and the second electrode are adjacent to the substrate surface.

16. The micro droplet controlling apparatus as claimed in claim 12, further comprises a hydrophobic layer interposed the micro droplet and the dielectric layer.

17. A micro droplet controlling apparatus, comprising:
a substrate;
a dielectric layer disposed overlying the substrate;
a plurality of first electrodes disposed in the dielectric layer;
a plurality of second electrodes disposed overlying the dielectric layer, wherein the first electrodes does not overlap the second electrodes;
a hydrophobic layer disposed over the dielectric layer, covering the second electrodes; and
a micro droplet disposed overlying the hydrophobic layer, wherein the first electrodes and the second electrodes are applied with voltage to generate a driving force to move the micro droplet.

18. A micro droplet controlling apparatus as claimed in claim 17, wherein the first electrode is adjacent to the substrate surface.

19. The micro droplet controlling apparatus as claimed in claim 17, wherein the second electrode is electrically ground.

20. A method for controlling a micro droplet, comprising:
providing a plurality of first electrodes in row direction overlying a substrate;
providing a plurality of second electrodes in column direction overlying a substrate to form a matrix with the first electrodes, wherein the first electrodes not overlap the second electrodes;
forming a hydrophobic layer, covering the first electrodes and the second electrodes;
providing at least a micro droplet on the hydrophobic layer; and
conducting the first electrodes and the second electrodes row by row or column by column using a matrix scanning method to generate a driving force to move the micro droplet.

21. The method for controlling a micro droplet as claimed in claim 20, wherein frequency of the matrix scanning method is substantially greater than 30 Hz per droplet.
